(19) United States
(12) Patent Application Publication
(10) Pub. No.: US 2010/0050453 A1
(43) Pub. Date: Mar. 4, 2010

(54) Tiling Tool

(76) Inventor: Colin Bryce, Surrey (GB)

Correspondence Address: NIXON & VANDERHYE, PC, 901 NORTH GLEBE ROAD, 11TH FLOOR, ARLINGTON, VA, 22203, US

(21) Appl. No.: 12/311,749

(22) PCT Filed: Sep. 24, 2007
(86) PCT No.: PCT/GB2007/050579

§ 371 Date: Apr. 10, 2009

(30) Foreign Application Priority Data
Sep. 29, 2006 (GB) 0619208.2
Jun. 4, 2007 (GB) 0710594.3

(51) Int. Cl. G01B 1/00

(52) U.S. Cl. 33/527

(57) ABSTRACT

The present invention provides a tiling tool (10) for assisting with the alignment and marking of tiles to be cut comprises: a body portion (14) and a handle portion (16), in which said body portion (14) includes a first step (18) having a height H¹ substantially equal to a gap G between already affixed tiles and into which it is insertable and a second step portion (20) adjacent thereto and having a height H² substantially equal to or greater than the gap G and including an upper surface (22) onto which, in operation, a tile to be cut may be placed and located. In combination with a template, which may be a further tile, the tool allows an operator to position, mark and then cut a tile along a cut line which accurately reflects the angle of a boundary that is other than parallel to the line of tiles already positioned on a wall or floor.

The present invention relates to a tool and relates particularly, but not exclusively, to a tiling tool for assisting a user position, mark and then cut a tile for insertion into a space having other than perpendicular boundaries.

One of the main difficulties associated with tiling floors or walls is cutting a tile to fit a gap between already laid tiles and a boundary such as a ceiling, corner or obstacle which has a confronting surface that extends in a direction other than parallel with the line of the tiles already laid. Whilst there are a number of possible solutions to this problem, a user is usually faced with the difficult task of measuring or estimating the correct angle and line along which a tile must be cut in order to create a close fit to the non-parallel surface. Often, the outcome is a tile cut to an approximation of the required line and the cut itself is often displaced relative to that desired. The resulting fit can be less than perfect.

The present invention aims to provide a tool which assist a user in determining, marking and then cutting an accurate replication of a tile needed to be inserted into a space having other than perpendicular boundaries. The tool itself may be used on floor or wall tiles and may be used on tiles having various thicknesses and size.

Accordingly, the present invention provides a tiling tool for assisting with the alignment and marking of tiles to be cut comprising: a body portion and a handle portion in which said body portion includes a first step having a height H¹ substantially equal or greater than a gap G between already affixed tiles and into which it is insertable and a second step portion adjacent thereto and having a height H² also substantially equal to or greater than the gap G and including an upper surface onto which, in operation, a tile to be cut may be placed and located. This tool may be used to support a tile to be cut for insertion in a gap between an already secured tile and a non-parallel boundary. In operation the supported tile is displaced towards the non-parallel boundary by an amount equal to the gap G between secured tiles and allows the operator to overlay a template tile aligned to the non-parallel boundary and then use an edge of said template tile to mark the tile to be cut. This will create a tile having an accurate replication of the non-parallel boundary and which can be inserted into the gap between an already secured tile and said boundary whilst ensuring a professional alignment and position of the cut edge relative to the non-parallel boundary.

The present invention will now be more particularly descried by way of example only with reference to the accompanying drawings in which:

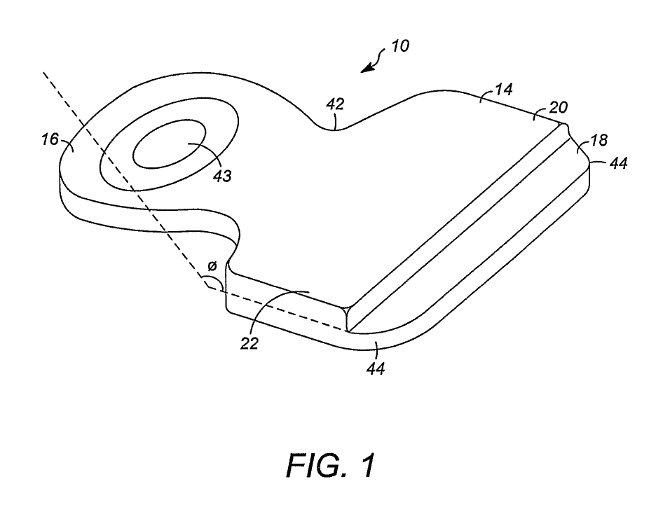

FIG. 1 is an isometric projection of a tool according to the present invention;

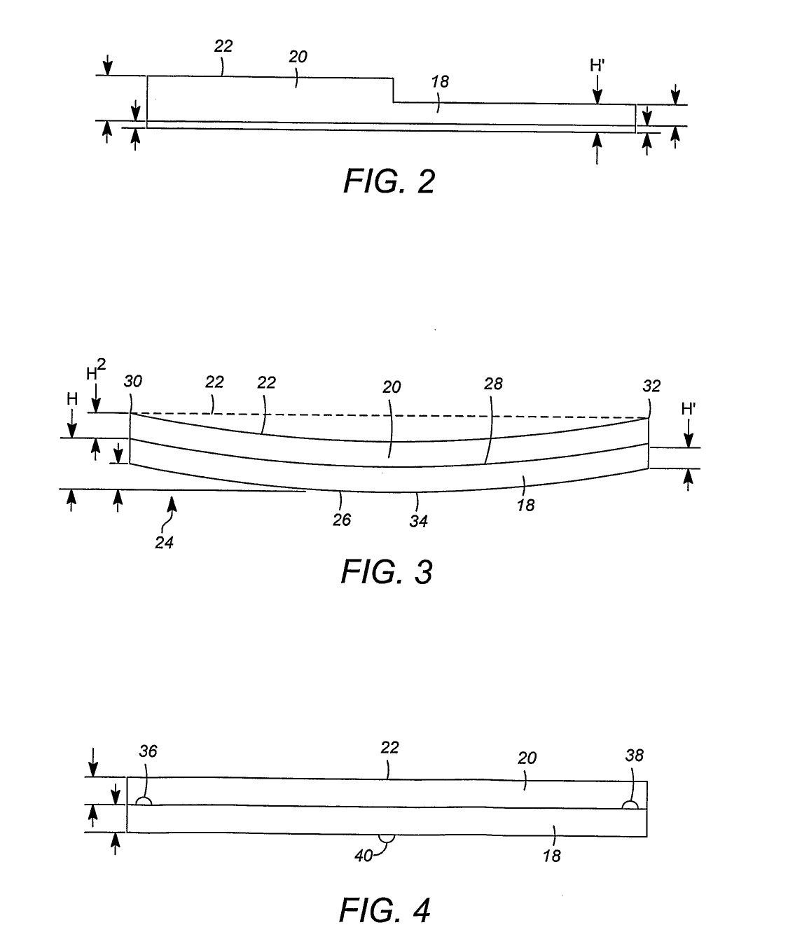

FIG. 2 is a side elevation of one arrangement of the present invention;

FIG. 3 is an end elevation of the arrangement of FIG. 2;

FIG. 4 is an end elevation of an alternative form of the present invention;

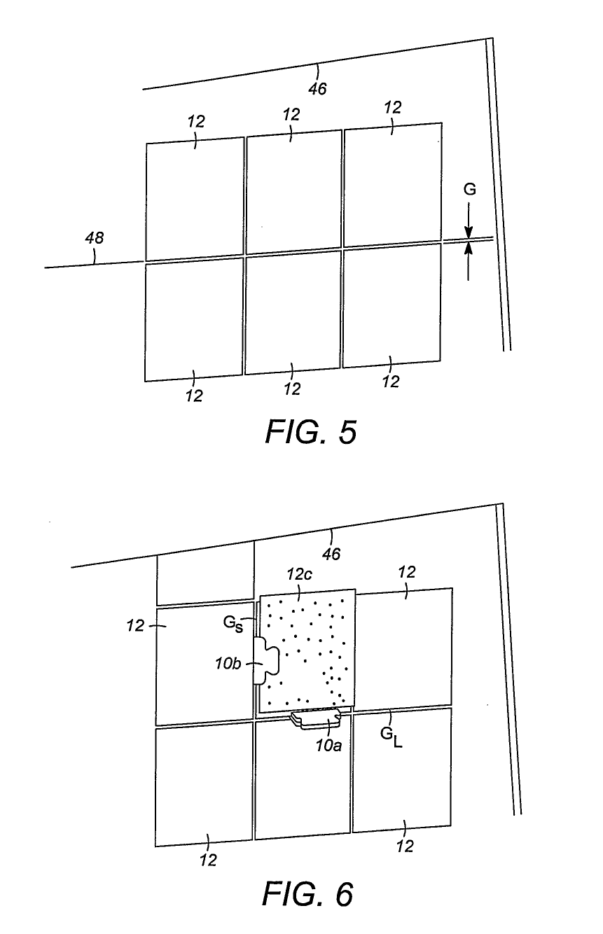

FIGS. 5 to 9 illustrate a sequence associated with positioning, marking, cutting and inserting a tile to be inserted into a space having a non-parallel boundary;

FIG. 10 is a cross-sectional view of the above-illustrated arrangement and illustrates the way in which a user may position the tile to be cut, position a template tile and mark the cutting line; and

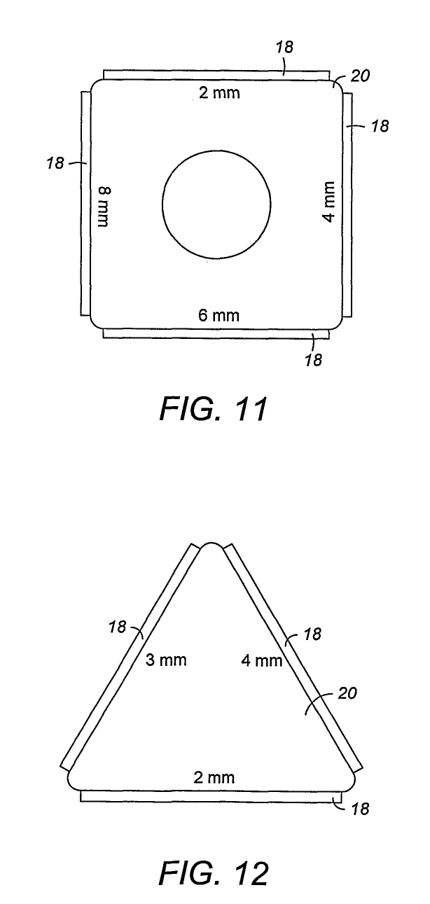

FIGS. 11 and 12 are an illustration of one arrangement of the present tool having a number of tool stations.

Referring now to the drawings in general but particularly to FIG. 1, a tool 10 for assisting a user to position, mark and cut a tile 12 to be inserted into a gap having a non-parallel boundary comprises a body portion 14 and a handle portion 16 associated therewith. The body portion is provided with a first step 18 having a height H¹ which is sized such as to be substantially equal to a gap G between tiles 12 that have already been positioned on the surface being tiled. This gap is normally subsequently filled with grout material (not shown) and is often defined by tile spacers (not shown), generally positioned at the intersection of the tiles and acting to position and space the tiles relative to the tiles adjacent thereto. This gap, however, is employed by the present invention as a platform for the location of the tile to be cut, as will be described in more detail later herein. The tool 10 further includes a second step 20 having a height H² also substantially equal to the gap G and having an upper surface 22 onto which, in operation, a tile to be cut may be positioned and retained for subsequent marking. The first step 18 is preferably provided with a gripping portion shown generally at 24 for assisting the step being retained within the gap G once inserted. Whilst it will be appreciated that the gripping means may comprise any one of a number of suitable alternatives, it has been found that a particularly suitable arrangement may be provided by forming the first step such as to have a curved profile forming a convex side 26 and a concaved side 28, the end 30, 32 and mid portions 34 of which act to define contact points and in which the height H between said points is slightly greater than a gap G into which said step is to be inserted. Such an arrangement will have a degree of flexibility if the step is formed from compliant material such as a plastic or metal and, in operation, acts to flatten the curve as the step is inserted in the gap G such as to create a degree of frictional engagement which causes the tool to be retained within said gap. Other functional equivalents of the curved portion are possible. For example, one may place a pair of projections 36 and 38 at opposite ends of a first side of said step and a corresponding projection 40 at a mid point on a second side of said first step 18, as shown in FIG. 4. Such an arrangement creates points of interference between the step 18 and the gap G into which is to be inserted and thereby acts to grip the adjacent tiles once inserted. A still further arrangement may comprise a resilient material (not shown) applied to a side or both sides of the step itself, said resilient material acting to deform when inserted into a tight gap G and retain the tool therein by means of the reaction force it exerts.

Other features of the present invention are best seen by reference, once again, to FIG. 1, which illustrates the handle portion 16 in more detail. Particular features include a thinned portion 42 for receiving a user's fingers and thereby to assist with the accurate positioning and easy removal of the tool from any gap G into which it is inserted. Also shown on the handle portion is a dimple portion 43 for receiving the tips of a user's fingers during operation and allowing for some degree of tactile positional recognition. In addition to the features described above, the tool 10 may further include chamfered corners 44 and may further include a handle portion extending in a plane at an angle θ relative to the plane P of the main step portions themselves. Such features assist with easy insertion of the tool into gap G and allow the tool to be used in tight corners where access may be difficult.

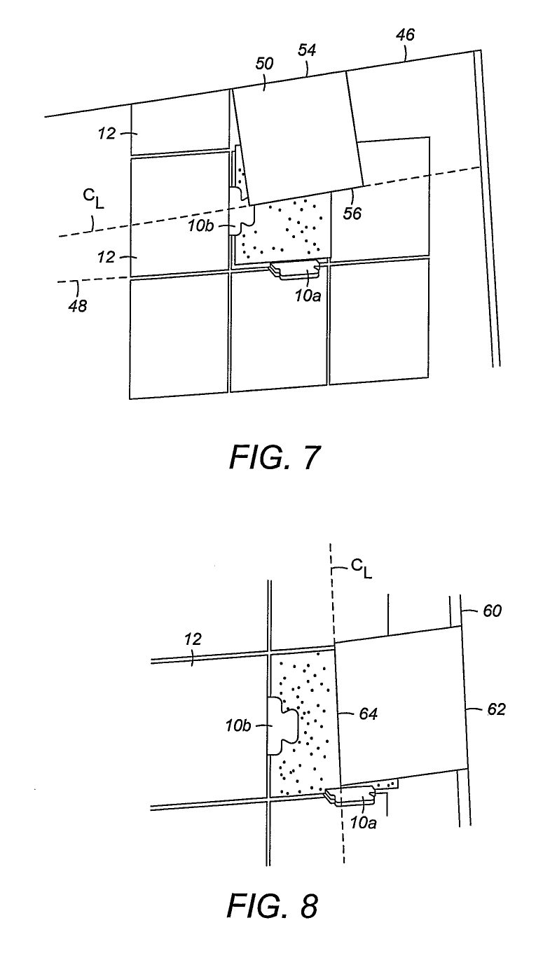

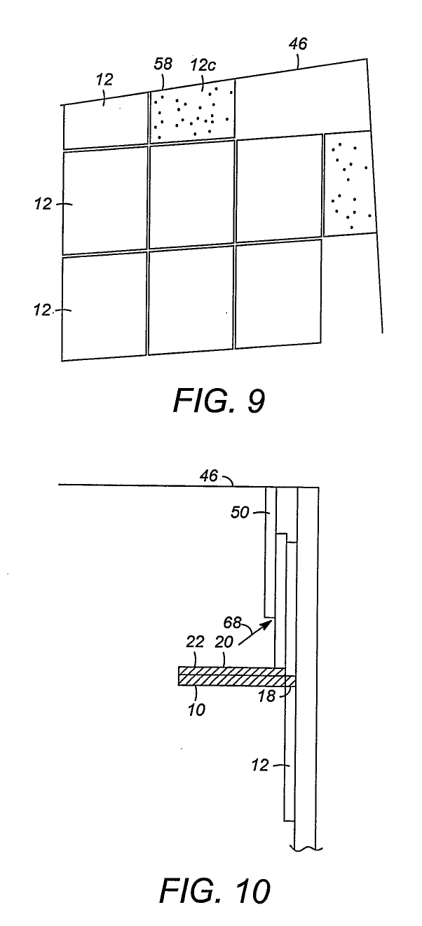

Referring now to FIGS. 5 to 9 which illustrate the process of positioning, marking, cutting and fitting a tile 12, it will be appreciated that an edge, such as a ceiling line 46 may extend at an angle other than parallel to the line of tiling 48. When this problem presents itself to a user the user simply needs to insert one tool 10 into each of the lower and the side gaps G_{L} and G_{S} of the tile below the space to be tiled such that the second step 20 of each confront each other, as shown. The tile to be cut 12c for insertion on the untilled space above the tile to which the inserts have been located is then placed onto the tools 10 as shown in FIG. 6 such that it rests on the lower tool 10a and is located by the side tool 10b. In effect, the tile to be cut 12c is held in a position spaced upwardly by towards the ceiling by an amount equal to the height H² of the second step 20 and this corresponds to the grout line gap width G and is significant for reasons that will become more apparent later herein. The next step is shown in FIG. 7 in which a template 50, which may be a further tile 12, is placed over the tile to be cut and an upper edge thereof 54 is positioned abutting up against the ceiling line 46. The opposite edge 56 of the template 50 may now be employed as a straight edge along which the user may scribe a cutting line C_{L} onto the tile to be cut, using the template edge 56 as a guide. Once the tile has been suitably marked it may be removed and cut by any conventional means such as a rotary tile cutter or the like before being inserted into the space for which it is intended. The correctly cut ceiling tile is shown as the dotted upper tile in FIG. 9, from which it will be appreciated that the cut edge 58 is now adjacent the ceiling line 46 and accurately reflects the angle thereof. The fact that the second step 20 has a height equal to the gap G means that a tile supported therein for marking and subsequent cutting will be being held in a position such as to cause the line marked thereon to be appropriately positioned such that when the tile is cut along the marked line the cut edge is both parallel to the ceiling line 46 and also appropriately positioned such that the bottom edge of the cut tile can be positioned within the space to be tiled, whilst maintaining an appropriate gap G at the bottom thereof. The gap itself is subsequently filled with grout material along with all the other gap portions.

FIG. 8 illustrates the arrangement necessary for positioning; marking and cutting a tile to be inserted between a tile already positioned on a wall and a side wall 60 which also does not extend parallel to the edge of the lain tiles. The only difference with the arrangement here is that the template tile is placed such as to allow a side edge 62 to abut up against the non-parallel wall edge and the opposite side 64 is used as a guide to allow a line to be drawn onto the tile to be cut.

FIG. 10 illustrates in more detail the positioning arrangement of tile and template as discussed above. From this figure it will be appreciated that the tool 10 is inserted into the gap G between already positioned tiles such that the second step remains proud of the gap G and the upper surface thereof 66 is raised above the gap itself. The tile to be cut 12 is then placed on the tool 10 such that it rests on the upper surface 22 and is thus displaced vertically by an amount equal to the height H² of the second step 20. Once the tile to be cut is securely positioned a template 50 in the form of, for example, a spare tile is placed over the tile to be cut such that an upper edge abuts up against the ceiling line 46. The lower edge of the template 50 may then be used as a guide to allow a cutting line to be marked on the tile to be cut, as indicated by arrow 68. The cutting of said tile along the marked line and fixing within the desired space is a process well known to those skilled in the art and therefore not described herein.

In an alternative form of the present invention the height H² is selected to be slightly greater than gap G, thereby to allow the tile to be cut to be marked and then cut just slightly short of the ceiling 46 portion against which it will, in use, abut. This additional height may be just enough to facilitate easy insertion of the tile or it may be such as to create a grouting gap along the ceiling line. The grouting gap may be equal to the gap G present between already positioned tiles. This arrangement is of particular use when the ceiling line is an actual edge causing an obstacle rather than just a line on a wall or floor.

It will also be appreciated that a plurality of said tools may be combined in one product. For example, the tool may comprise two or more stations 76, each station having a first and second step pair 18, 20, each having a different step height to that of another. This would allow a single tool to be provided with a step suitable for use with different gap widths G as might be present when tiling floor and wall tiles. Such an arrangement is shown in FIGS. 11 and 12. In either arrangement a hole 70 may be provided in the centre of the tool 10 so as to facilitate easy handling. The tool 10 may be provided as part of a kit, each kit containing two or more tools 10 having different step heights H¹ and to H² one or more tools in the pack. Alternatively, the tools may be sold in pairs or groups having the same step heights as each other.

It will also be appreciated that the above tool may be provided with a coupling arrangement 70 such as, for example, indents 72 on one portion thereof for engagement with corresponding detents 74 on an associated portion of a further tool. Such a coupling may be used to keep a number of tools secure when not being used and allows said tools to be decoupled for use as and when required.

1. A tiling tool (10) for assisting with the alignment and marking of tiles to be cut comprises: a body portion (14) and a handle portion (16), in which said body portion (14) includes a first step (18) having a height (H¹) substantially equal to a gap (G) between already affixed tiles and into which it is insertable and a tile gripping portion for gripping tiles on either side of said gap G and a second step portion (20) adjacent thereto and having a height (H²) substantially equal to the gap (G) and including an upper surface (22) onto which, in operation, a tile to be cut may be placed and located.

2. A tiling tool as claimed in claim 1 wherein said first portion has a curved profile forming a convex side and a concaved side, the end and mid portions of which act to define contact points and in which the height H between said points is slightly greater than a gap (G) into which said step is to be inserted, thereby to provide a degree of frictional engagement within said gap (G).

3. A tiling tool as claimed in claim 1 wherein said gripping portion comprises a pair of projections at opposite ends of a first side of said step and a corresponding projection at a mid point on a second, side of said first step.

4. A tiling tool as claimed in claim 1 wherein said gripping portion comprises a resilient material.

5. A tiling tool as claimed, in claim 1 wherein said first step has a depth (D) substantially equal to a tile thickness.

6. A tiling tool as claimed in claim 1 wherein said handle portion includes a thinned section for receiving the fingers of a user.

7. A tiling tool as claimed in claim 1 wherein said handle portion further Includes a dimpled portion on a flat surface thereof for receiving the fingers of a user.

8. A tiling tool as claimed in claim 1 wherein said handle extends in a plane angled relative to the plane of said first step.

9. A tiling tool as claimed in claim 1 wherein said tool includes a coupling portion for coupling to a corresponding coupling portion on another tiling tool.

10. A tiling tool as claimed in claim 9 wherein said coupling portions comprises indents and detents provided on confronting faces of said corresponding tools and said indents and detents are sized such as to frictionally engage with one an other.

11. A tiling tool as claimed in claim 1 wherein said tool comprises a plurality of stations and two or more of said stations include first and a second step pairs, each step pair having a different height to that of the other, thereby to allow the tool to be used on tiles having different grout gaps (G).

12. A kit comprising multiple tiling tools according to claim 1.

13. A kit of parts comprising multiple tiling tools, according to claim 1 wherein two or more of said tools comprise tools having different step heights (H¹) and (H²) to one or more of the other tools within the pack.

14. A method for aligning and marking tiles comprising the steps of:
(i) providing at least two tiling tools (10) comprising a body portion (14) and a handle portion (16), in which said body portion (14) includes a first step (18) having a height (H¹) substantially equal to a gap (G) between already affixed tiles and into which it is insertable and a second step portion (20) adjacent thereto and’ having a height (H²) substantially equal to the gap (G) and including an upper surface (22) onto which, in operation, a tile to be cut may be placed and located;
(ii) inserting one of said tiling tools (10a, 10b) into each of a lower and a side gap (G_{L}) and (Gₛ) of a tile located below the space to be tiled;
(iii) positioning a tile to be cut (12c) such that it rests on the lower tool (10a) and is located by the side tool (10b);
(iv) placing a template (50) over the tile to be cut (12c) thereby positioning an upper edge thereof (54) abutting up against a ceiling line (46);
(v) marking said tile to be cut (12c) using an ‘opposite edge (56) of said template (50) as a guide such that a cutting line (C_{L}) is provided extending across said tile to be cut (12c) and substantially parallel to the ceiling line (46) which facilitate the cut of tile (12c) therealong thereby providing a tile portion suitably sized to fit within the space to be tiled.
